(19) United States
(12) Patent Application Publication
(10) Pub. No.: US 2026/0270041 A1
(43) Pub. Date: Sep. 10, 2026

(54) SYSTEM AND METHOD FOR PRIVACY-PRESERVING LARGE LANGUAGE MODEL INFERENCE VIA FULLY HOMOMORPHIC ENCRYPTION

(71) Applicant: JPMorgan Chase Bank, N.A., New York, NY (US)

(72) Inventors: Daniel Esteban ESCUDERO OSPINA, Long Island City, NY (US); Antigoni Ourania POLYCHRONIADOU, New York, NY (US); Tucker Richard BALCH, Suwanee, GA (US); Leo DE CASTRO, Mountain View, CA (US)

(73) Assignee: JPMorgan Chase Bank, N.A., New York, NY (US)

(21) Appl. No.: 19/186,308

(22) Filed: Apr. 22, 2025

(30) Foreign Application Priority Data
Mar. 10, 2025 (GR) 20250100176

(51) Int. Cl. H04L 9/00; G06F 40/284; H04L 9/08

(52) U.S. Cl. CPC H04L 9/008; G06F 40/284; H04L 9/0861

(57) ABSTRACT

Various methods and processes, apparatuses or systems, and media for providing a fully homomorphic encryption (FHE)-based privacy-preserving large language model (LLM) inference via a graphics processing unit (GPU)-based implementation are disclosed. The method includes: receiving an encrypted query; providing, to an LLM, a GPU-based implementation of a transformer architecture that is configured to accelerate homomorphic operations of the LLM; inputting the encrypted query into the LLM with the GPU-based implementation of the transformer architecture, where the LLM is unable to decrypt the query; receiving an encrypted response to the query from the LLM; and decrypting the encrypted response.

### CROSS-REFERENCE TO RELATED APPLICATIONS

This application claims priority from Greek Patent Application No. 20250100176, filed in the Greek Patent Office on Mar. 10, 2025, which is hereby incorporated by reference in its entirety.

### TECHNICAL FIELD

This disclosure generally relates to applying a large language model (LLM)-based approach to work on encrypted queries and data, and more particularly, to methods and apparatuses for providing a fully homomorphic encryption (FHE)-based privacy-preserving LLM inference via a graphics processing unit (GPU)-based implementation.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Large language models (LLMs) have proven to be groundbreaking artificial intelligence (AI) tools that are set to change the way humans interact with software. By training on massive amounts of data and using an incredibly large amount of trainable parameters, LLMs are able to provide unprecedented inference results. The tasks at which LLMs excel include natural language generation, question answering, summarization, translation, and code generation, among several others. LLMs can produce coherent and contextually appropriate text on a wide range of topics. However, these models require massive amounts of resources to be trained, and are often not publicly available as this may constitute the provider's intellectual property. This often leads to an “inference-as-a-service” scenario, where clients send their queries to external providers who locally run an LLM to return a result to the client. Further, even open source LLMs are typically very expensive to run in commodity hardware and still often require delegation to a third party provider.

Unfortunately, delegating inference is undesirable in many settings where the client wants to preserve the privacy of their input. Further, there are many contexts in which the model owner also wants to retain privacy of the model itself, such as, for example, when the model involves massive monetary resources to be trained, or when the model incorporates sensitive data (e.g., a bank servicing a credit score model trained on internal data). This is particularly relevant as LLMs become more pervasive and find more use-cases that permeate all areas of society. This tension between privacy and utility heavily limits the applicability of LLMs, rendering them useless in contexts where data cannot be outsourced due to privacy constraints.

Towards resolving this tension, fully homomorphic encryption (FHE) is a promising tool that enables computing on data without revealing the data. Using FHE, a client can encrypt their query to the server, who can locally apply their model to this encrypted data, making use of the homomorphic properties of the scheme to obtain an encrypted result, which is then sent back to the client for decryption. In recent years, various advances in algorithms, software, and hardware have made FHE more practical for several tasks. However, LLMs are in an entirely different regime: their computation is already very expensive in the clear, up to the point in which specialized software coupled with architectural optimizations may be needed to provide a reasonable inference latency.

Accordingly, there is a need for a mechanism for providing an FHE-based privacy-preserving LLM inference via a graphics processing unit (GPU)-based implementation.

### SUMMARY

The present disclosure, through one or more of its various aspects, embodiments, and/or specific features or sub-components, provides, among other features, various systems, servers, devices, methods, media, programs, and platforms for providing an FHE-based privacy-preserving LLM inference via a GPU-based implementation.

According to an aspect of the present disclosure, a method for providing a privacy-preserving LLM inference is provided. The method may be implemented by at least one processor. The method includes: receiving, from a user, a query that is encrypted; providing, to an LLM, a graphics processing unit (GPU)-based implementation of a transformer architecture that is configured to accelerate homomorphic operations of the LLM; inputting the query into the LLM with the GPU-based implementation of the transformer architecture; receiving, from the LLM, an encrypted response to the query; and decrypting the encrypted response. The LLM is unable to decrypt the query.

The query may be encrypted by: using a tokenizer of the LLM to transform text included in the query into a sequence of real-valued vectors; and encrypting the sequence of real-valued vectors by using a predetermined encryption algorithm.

The query may be encrypted by using a fully homomorphic encryption (FHE) scheme.

The FHE scheme may include: a key generation algorithm that is configured to generate a public key that is usable for encryption, a secret key that is usable for decryption, and an evaluation key; an encryption algorithm that is configured to apply the public key to an input message to generate an output ciphertext; a decryption algorithm that is configured to apply the secret key to an input ciphertext to generate an output message; and a homomorphic evaluation algorithm that is configured to apply the evaluation key to an input ciphertext for a first message and an input function to generate an output ciphertext that encrypts a result of encrypting a result of applying the input function to the first message.

The GPU-based implementation of the transformer architecture may include a GPU-accelerated Cheon-Kim-Kim-Song (CKKS) FHE scheme. The CKKS FHE scheme may include a key switching algorithm that is configured to increase a modulus of the input ciphertext, perform at least one homomorphic operation on the input ciphertext at the increased modulus, and decrease the modulus of the input ciphertext.

The CKKS FHE scheme may include performing each of an encrypted addition operation, an encrypted multiplication operation, and an encrypted rotation operation.

The CKKS FHE scheme may further include using at least one polynomial approximation for replacing at least one function of the transformer architecture with a function that is operable on encrypted data. The at least one polynomial approximation may be based on a selection of parameters that are optimized for a balance between a runtime of the CKKS FHE scheme and an accuracy of the LLM.

The CKKS FHE scheme may have a plaintext space that corresponds to a set having a dimension that is equal to 65,536.

The LLM may include an open-source LLM.

According to another embodiment, a computing apparatus for providing a privacy-preserving LLM inference is provided. The computing apparatus includes a processor; a memory; and a communication interface coupled to each of the processor and the memory. The processor is configured to: receive, from a user via the communication interface, a query that is encrypted; provide, to an LLM, a GPU-based implementation of a transformer architecture that is configured to accelerate homomorphic operations of the LLM; input the query into the LLM with the GPU-based implementation of the transformer architecture; receive, from the LLM, an encrypted response to the query; and decrypt the encrypted response. The LLM is unable to decrypt the query.

The query may be encrypted by: using a tokenizer of the LLM to transform text included in the query into a sequence of real-valued vectors; and encrypting the sequence of real-valued vectors by using a predetermined encryption algorithm.

The query may be encrypted by using a fully homomorphic encryption (FHE) scheme.

The FHE scheme may include: a key generation algorithm that is configured to generate a public key that is usable for encryption, a secret key that is usable for decryption, and an evaluation key; an encryption algorithm that is configured to apply the public key to an input message to generate an output ciphertext; a decryption algorithm that is configured to apply the secret key to an input ciphertext to generate an output message; and a homomorphic evaluation algorithm that is configured to apply the evaluation key to an input ciphertext for a first message and an input function to generate an output ciphertext that encrypts a result of encrypting a result of applying the input function to the first message.

The GPU-based implementation of the transformer architecture may include a GPU-accelerated Cheon-Kim-Kim-Song (CKKS) FHE scheme. The CKKS FHE scheme may include a key switching algorithm that is configured to increase a modulus of the input ciphertext, perform at least one homomorphic operation on the input ciphertext at the increased modulus, and decrease the modulus of the input ciphertext.

The CKKS FHE scheme may include performing each of an encrypted addition operation, an encrypted multiplication operation, and an encrypted rotation operation.

The CKKS FHE scheme may further include using at least one polynomial approximation for replacing at least one function of the transformer architecture with a function that is operable on encrypted data. The at least one polynomial approximation may be based on a selection of parameters that are optimized for a balance between a runtime of the CKKS FHE scheme and an accuracy of the LLM.

The CKKS FHE scheme may have a plaintext space that corresponds to a set having a dimension that is equal to 65,536.

The LLM may include an open-source LLM.

According to yet another embodiment, a non-transitory computer readable storage medium storing instructions for providing a privacy-preserving LLM inference is provided. The storage medium includes a set of executable code which, when executed by a processor, causes the processor to: receive, from a user, a query that is encrypted; provide, to an LLM, a GPU-based implementation of a transformer architecture that is configured to accelerate homomorphic operations of the LLM; input the query into the LLM with the GPU-based implementation of the transformer architecture; receive, from the LLM, an encrypted response to the query; and decrypt the encrypted response. The LLM is unable to decrypt the query.

The query may be encrypted by: using a tokenizer of the LLM to transform text included in the query into a sequence of real-valued vectors; and encrypting the sequence of real-valued vectors by using a predetermined encryption algorithm.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for providing an FHE-based privacy-preserving LLM inference via a GPU-based implementation, in accordance with an embodiment.

FIG. 2 illustrates an exemplary diagram of a network environment with a device for providing an FHE-based privacy-preserving LLM inference via a GPU-based implementation, in accordance with an embodiment.

FIG. 3 illustrates a system diagram for implementing a method for providing an FHE-based privacy-preserving LLM inference via a GPU-based implementation, in accordance with an embodiment.

FIG. 4 illustrates an exemplary flow chart of a process for providing an FHE-based privacy-preserving LLM inference via a GPU-based implementation, in accordance with an embodiment.

FIG. 5 illustrates a first algorithm that functions as a first optimization of a key-switching operation in a process for providing an FHE-based privacy-preserving LLM inference via a GPU-based implementation, in accordance with an embodiment.

FIG. 6 illustrates a second algorithm that functions as a second optimization of the key-switching operation in a process for providing an FHE-based privacy-preserving LLM inference via a GPU-based implementation, in accordance with an embodiment.

FIG. 7 illustrates a third algorithm that functions as a third optimization of the key-switching operation in a process for providing an FHE-based privacy-preserving LLM inference via a GPU-based implementation, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

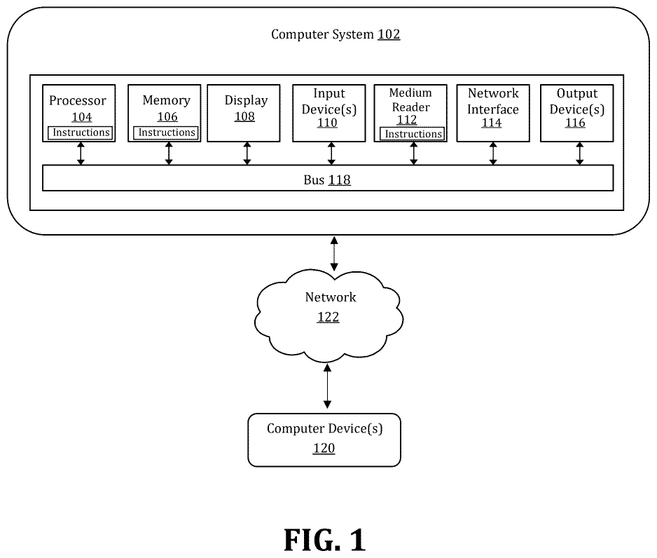

FIG. 1 is an exemplary system 100 for use in implementing a method for providing an FHE-based privacy-preserving LLM inference via a GPU-based implementation, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain't Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

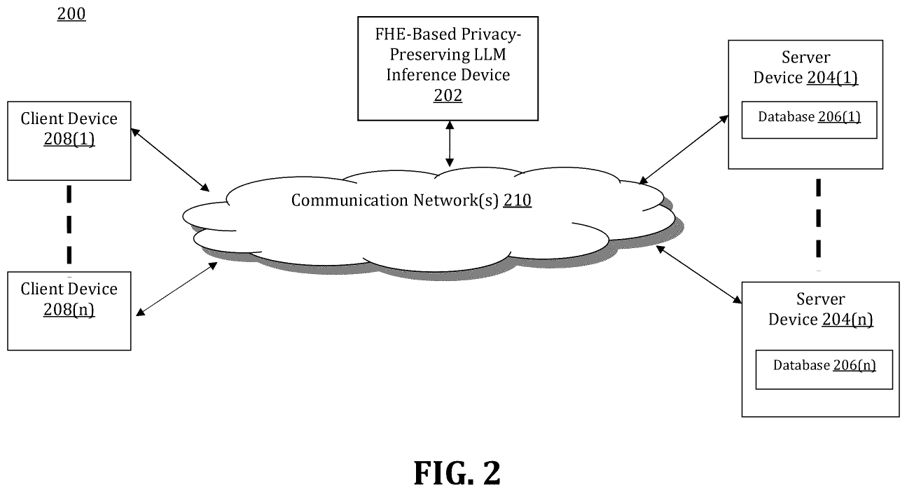

Referring to FIG. 2, a schematic of an exemplary network environment 200 for implementing an FHE-based privacy-preserving LLM inference device (FPPLID) of the instant disclosure is illustrated.

In some embodiments, the above-described problems associated with conventional tools may be overcome by implementing an FPPLID 202 as illustrated in FIG. 2 that may be configured for implementing a method for providing an FHE-based privacy-preserving LLM inference via a GPU-based implementation, but the disclosure is not limited thereto.

The FPPLID 202 may have one or more computer system 102s, as described with respect to FIG. 1, which in aggregate provide the necessary functions.

The FPPLID 202 may store one or more applications that can include executable instructions that, when executed by the FPPLID 202, cause the FPPLID 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the FPPLID 202 itself, may be located in virtual server(s) running in a cloud-based computing environment rather than being tied to one or more specific physical network computing devices. Also, the application(s) may be running in one or more virtual machines (VMs) executing on the FPPLID 202. Additionally, in one or more embodiments of this technology, virtual machine(s) running on the FPPLID 202 may be managed or supervised by a hypervisor.

In the network environment 200 of FIG. 2, the FPPLID 202 is coupled to a plurality of server devices 204(1)-204(n) that hosts a plurality of databases 206(1)-206(n), and also to a plurality of client devices 208(1)-208(n) via communication network(s) 210. A communication interface of the FPPLID 202, such as the network interface 114 of the computer system 102 of FIG. 1, operatively couples and communicates between the FPPLID 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the FPPLID 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The FPPLID 202 may be a standalone device or integrated with one or more other devices or apparatuses, such as one or more of the server devices 204(1)-204(n), for example. In one particular example, the FPPLID 202 may be hosted by one of the server devices 204(1)-204(n), and other arrangements are also possible. Moreover, one or more of the devices of the FPPLID 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the FPPLID 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the FPPLID 202 that may efficiently provide a platform for implementing a method for providing an FHE-based privacy-preserving LLM inference via a GPU-based implementation, but the disclosure is not limited thereto.

The client devices 208(1)-208(n) may run interface applications, such as standard web browsers or standalone client applications, which may provide an interface to communicate with the FPPLID 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the FPPLID 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the FPPLID 202, the server devices 204(1)-204(n), or the client devices 208(1)-208(n), for example, may be configured to operate as virtual instances on the same physical machine. For example, one or more of the FPPLID 202, the server devices 204(1)-204(n), or the client devices 208(1)-208(n) may operate on the same physical device rather than as separate devices communicating through communication network(s) 210. Additionally, there may be more or fewer FPPLIDs 202, server devices 204(1)-204(n), or client devices 208(1)-208(n) than illustrated in FIG. 2. In some embodiments, the FPPLID 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

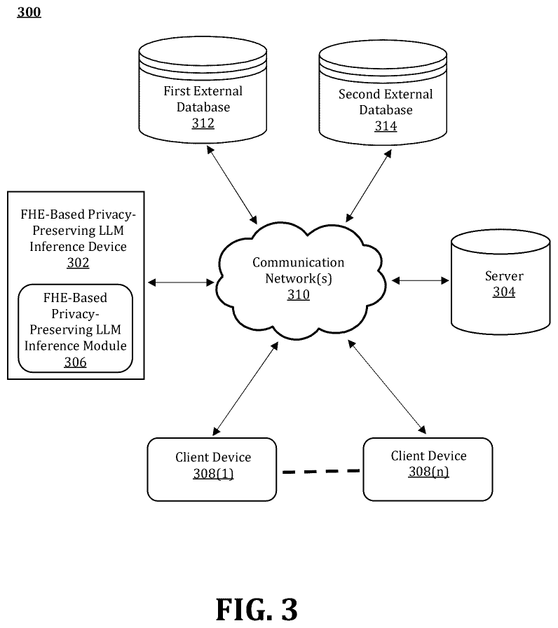

FIG. 3 illustrates a system diagram for implementing an FPPLID 302 having an FHE-based privacy-preserving LLM inference module (FPPLIM), in accordance with an embodiment.

As illustrated in FIG. 3, the system 300 may include an FPPLID 302 within which an FPPLIM 306 is embedded, a server 304, a first external database 312, a second external database 314, a plurality of client devices 308(1) . . . 308(n), and a communication network 310.

In some embodiments, the FPPLID 302 including the FPPLIM 306 may be connected to the server 304, and the database(s) 312 via the communication network 310. The FPPLID 302 may also be connected to the plurality of client devices 308(1) . . . 308(n) via the communication network 310, but the disclosure is not limited thereto.

In an embodiment, the FPPLID 302 is described and shown in FIG. 3 as including the FPPLIM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the FPPLIM 306 may be configured to receive real-time feed of data from the plurality of client devices 308(1) . . . 308(n) and secondary sources via the communication network 310.

As may be described below, the FPPLIM 306 may be configured to provide a privacy-preserving LLM inference by: receiving, from a user, a query that is encrypted; providing, to a predetermined LLM, a graphics processing unit (GPU)-based implementation of a transformer architecture that is configured to accelerate homomorphic operations of the predetermined LLM; inputting the query into the predetermined LLM with the GPU-based implementation of the transformer architecture; receiving, from the predetermined LLM, an encrypted response to the query; and decrypting the encrypted response, where the predetermined LLM is unable to decrypt the query. However, the disclosure is not limited thereto.

The plurality of client devices 308(1) . . . 308(n) are illustrated as being in communication with the FPPLID 302. In this regard, the plurality of client devices 308(1) . . . 308(n) may be “clients” (e.g., customers) of the FPPLID 302 and are described herein as such. Nevertheless, it is to be known and understood that the plurality of client devices 308(1) . . . 308(n) need not necessarily be “clients” of the FPPLID 302, or any entity described in association therewith herein. Any additional or alternative relationship may exist between either or both of the plurality of client devices 308(1) . . . 308(n) and the FPPLID 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the FPPLID 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The FPPLID 302 may be the same or similar to the FPPLID 202 as described with respect to FIG. 2, including any features or combination of features described with respect thereto.

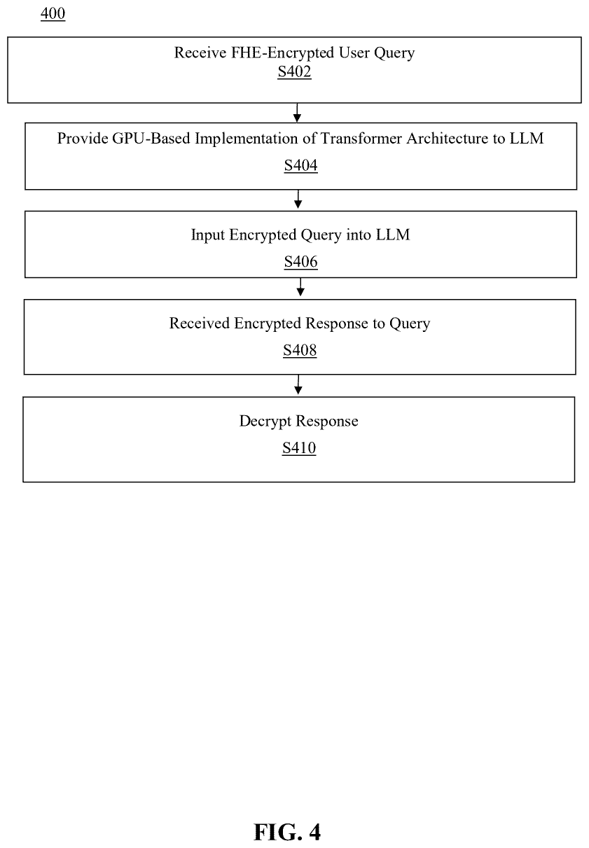

FIG. 4 illustrates an exemplary flow chart of a process 400 implemented by the FPPLIM 306 of FIG. 3 for enablement of a system and a method for providing an FHE-based privacy-preserving LLM inference via a GPU-based implementation, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step S402, the process 400 may include receiving, from a user, a query that is encrypted. In an embodiment, the query is encrypted by using a tokenizer of an LLM to transform text included in the query into a sequence of real-valued vectors, and then encrypting the sequence of real-valued vectors by using a predetermined encryption algorithm. In an embodiment, the LLM may be an open-source LLM.

In an embodiment, the query is encrypted by using a fully homomorphic encryption (FHE) scheme. In an embodiment, the FHE scheme may include: a key generation algorithm that is configured to generate a public key that is usable for encryption, a secret key that is usable for decryption, and an evaluation key; an encryption algorithm that is configured to apply the public key to an input message to generate an output ciphertext; a decryption algorithm that is configured to apply the secret key to an input ciphertext to generate an output message; and a homomorphic evaluation algorithm that is configured to apply the evaluation key to an input ciphertext for a first message and an input function to generate an output ciphertext that encrypts a result of encrypting a result of applying the input function to the first message.

At step S404, the process 400 may include providing, to the LLM, a graphics processing unit (GPU)-based implementation of a transformer architecture that is configured to accelerate homomorphic operations of the LLM. In an embodiment, the GPU-based implementation of the transformer architecture may include a GPU-accelerated Cheon-Kim-Kim-Song (CKKS) FHE scheme.

In an embodiment, the CKKS FHE scheme may include performing each of an encrypted addition operation, an encrypted multiplication operation, and an encrypted rotation operation. In an embodiment, the CKKS FHE scheme may also include using at least one polynomial approximation for replicating the transformer architecture. In an embodiment, the at least one polynomial approximation may be based on a selection of parameters that are optimized for a balance between a runtime of the CKKS FHE scheme and an accuracy of the LLM. In an embodiment, the CKKS FHE scheme may have a plaintext space that corresponds to a set having a dimension that is equal to a power of two, such as, for example, 2¹⁶=65,536. Alternatively, in other embodiments, the CKKS FHE scheme may have a plaintext space that corresponds to set having any suitable dimension, including sets having relatively smaller dimensions and/or sets having relatively larger dimensions.

In an embodiment, the CKKS FHE scheme may include a key switching algorithm. The majority of CKKS operations require a key switching routine, which is nearly always the most expensive step. The key switching algorithm is expensive because it performs operations on both the rows and the columns of a large matrix of data. This means that the algorithm accesses many disparate places in memory, which makes it difficult to arrange the memory in a way that is fast to access. The orientation of the memory accesses changes several times throughout key switching, splitting the algorithm into phases. In an embodiment, the algorithm is optimized by combining several such phases, in order to reduce the number of times that the data orientation must change. It has been shown that CKKS key switching is bottlenecked by memory bandwidth, so reducing the memory usage directly leads to a significant speed increase in execution of the algorithm. In an embodiment, this optimization is extended to an encrypted matrix multiplication algorithm, which may be used to combine the phases of many key switching routines, i.e., in proportion to the dimensions of the matrix, in order to dramatically reduce both the total operation count and the memory usage. Several steps in CKKS bootstrapping and LLM evaluation consist entirely of multiplying encrypted matrices, so this optimization yields significant improvements in the larger application.

In an embodiment, the key switching operation involves increasing the modulus of a ciphertext, performing operations over this larger modulus, then reducing the modulus back to the original value. Each of the modulus increasing operation and the modulus reducing operation requires a memory access orientation change. In an embodiment, the modulus of the first message may be efficiently increased to the larger modulus together with the rest of the ciphertext, in order to allow homomorphic computation to be performed between the modulus raising and lowering, which greatly reduces the number of modulus change operations. In addition, this process allows several lowering phases to be combined without changing the orientation for a message operation, which is important in encrypted matrix multiplication.

In an embodiment, high-precision encrypted computation techniques are integrated into the key switching algorithm. Conventional techniques involve computing special parameters for the key switching routine and potentially adding memory access phases to the algorithm. In an embodiment, these high-precision techniques are extended to fused key switching algorithms, and the fusing operation is also used for removing the additional memory phases from the high-precision techniques.

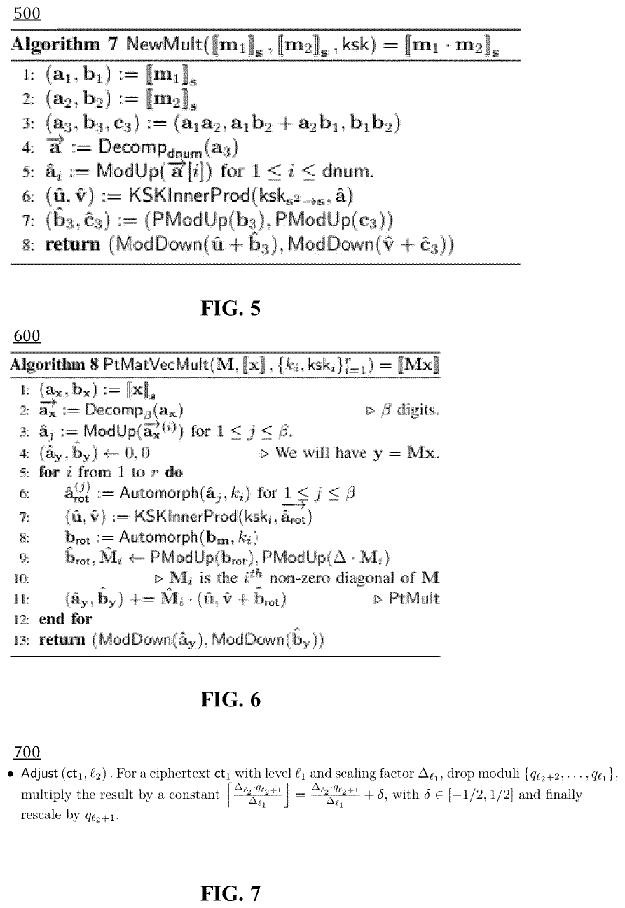

FIG. 5 illustrates a first algorithm 500 that functions as an optimization of a key switching operation in a process for providing an FHE-based privacy-preserving LLM inference via a GPU-based implementation, in accordance with an embodiment. FIG. 6 illustrates a second algorithm 600 that functions as another optimization of the key switching operation in a process for providing an FHE-based privacy-preserving LLM inference via a GPU-based implementation, in accordance with an embodiment. FIG. 7 illustrates a third algorithm 700 that functions as a third optimization of the key switching operation in a process for providing an FHE-based privacy-preserving LLM inference via a GPU-based implementation, in accordance with an embodiment.

As shown in FIGS. 5, 6, and 7, a multiplication operation for key switching with respect to encoded messages, a compression operation for reducing a size of the keys in the key switching operation, and an adjust function for rescaling the key switching operation are provided in order to reduce an approximation error in a Residue Number System (RNS) instantiation of CKKS. In FIG. 5, the variables a and b refer to two polynomials that comprise an mth ciphertext, and m refers to the index for that ciphertext. ModUp refers to an increase in the the RNS basis, and ModDown refers to a decrease in the RNS basis. In FIG. 6, x refers to a vector of a ciphertext, and the algorithm 600 functions to collapse a structure for an optimization of the key switching operation into a single step. In FIG. 7, for a ciphertext ct1 with level L1 and scaling factor Δ, the moduli are reduced, the result is multiplied by a constant, and the result thereof is rescaled. The end result of combining algorithm 700 with algorithms 500 and 600 is that an approximation error in the RNS instantiation of CKKS is substantially reduced.

At step S406, the process 400 may include inputting the encrypted query into the LLM with the GPU-based implementation of the transformer architecture. Then, at step S408, the process 400 may include receiving, from the LLM, an encrypted response to the query. Lastly, at step S410, the process 400 may include decrypting the encrypted response. In an embodiment, the LLM is unable to decrypt the query, but instead, the LLM takes advantage of the GPU-based implementation of the transformer architecture and the FHE properties of the encrypted query to perform all of the required operations upon the query to generate a response to the query without a need for decryption thereof. In this aspect, the process 400 effectively preserves the privacy of both the user and the LLM provider while also obtaining the desired response to the query.

In an embodiment, the process 400 is applicable to many situations that involve analyzing datasets of complex spreadsheets; creating summaries, reports, and/or insights from large datasets of documents; classifying documents; and conducting in-depth market reviews and/or in-depth code reviews. In an embodiment, a first use case may refer to a technical documentation and code review task, including drafting and/or refining technical documents and user manuals; conducting in-depth code reviews and suggesting optimizations; and providing examples, explanations, and scenarios for complex coding problems. In an embodiment, a second use case may refer to financial report analysis and summaries, including summarizing annual reports, earnings calls, and/or financial statements; providing insights and/or highlights for investors and/or business teams; and breaking down complex financial jargon for improved understanding and clarity. In an embodiment, a third use case may refer to portfolio analysis and investment strategy, including analyzing an investment portfolio of a user and suggesting diversification strategies; developing personalized investment strategies based on risk tolerance and goals; and tracking portfolio performance over time and recommending adjustments.

In an embodiment, a fourth use case may refer to market research and trend analysis, including conducting sector analysis and identifying emerging market trends; providing economic and industry forecasts based on historical data; and analyzing geopolitical and/or macroeconomic factors affecting financial markets. In an embodiment, a fifth use case may refer to financial modeling and forecasting, including assisting in building financial models for revenue, costs, and cash flows; providing insights for long-term projections based on company data and industry trends; and suggesting various forecast scenarios, such as optimistic scenarios and/or pessimistic scenarios.

In an embodiment, a sixth use case may refer to credit analysis and loan assessment, including analyzing credit reports and assessing creditworthiness; recommending ways to improve credit scores and manage debt effectively; and providing assessments of loan options and calculating potential savings. In an embodiment, a seventh use case may refer to algorithmic and quantitative financial support, including offering insights into back-testing and optimizing trading algorithms; helping develop and test quantitative finance models for trading strategies; and supporting Monte Carlo simulations, value at risk (VAR) analysis, and other quantitative techniques. In an embodiment, an eighth use case may refer to financial compliance and regulatory support, including assisting with understanding financial regulations, such as the European Union's General Data Protection Regulation (GDPR), the Markets in Financial Instruments Directive (MiFID), and/or the Sarbanes-Oxley (SOX) Act; creating summaries of regulatory requirements for compliance teams; and offering insights into anti-money laundering (AML) and fraud detection practices.

In an embodiment, the present inventive concept approaches the problem of improving the efficiency of FHE-based privacy-preserving inference by providing a GPU-based implementation of a transformer architecture of an LLM using a CKKS FHE scheme that enables approximate additions and multiplications over real and/or complex numbers. The use of a GPU-based workflow leads to direct efficiency improvements in many FHE applications, including the use of LLMs. In an embodiment, the use of the GPU-based implementation requires a deep understanding of the internal CKKS operations in order to replicate them on the GPU.

An LLM is a type of machine learning (ML) model that is characterized by its ability to predict language, with the “large” term emphasizing the comparatively gigantic size and computational demand required by an LLM. Many LLMs use a transformer architecture. Among LLMs, an interesting and relevant family is generative pretrained transformers (GPTs), which are used in natural language processing contexts. The GPT family has been widely influential. In an embodiment, a GPT may be fully open-source, and may follow a transformer architecture that is shared by more powerful LLMs that are not fully open-source.

LLMs use deep learning to analyze and generate human-like text. The transformer architecture receives as input a piece of text, which is split into numerical representations referred to as tokens. Transformers include an encoder section and a decoder section, which have very similar structures. However, generative LLMs are decoder-only.

The model is trained to predict the best next word given a sequence of words. For example, the model may receive as an input “Today is a good”, and then predict “day” as the next word. The resulting concatenated sentence “today is a good day” can be fed into the model again to obtain as the next word, perhaps, “for”. In this manner, a sequence such as “today is a good day for running outside” can be generated.

An FHE scheme is an encryption scheme that allows computations to be performed over the data while the data remains encrypted. In an embodiment, the FHE scheme is defined by the following tuple of algorithms:
1) Key generation algorithm: (sk, pk, evk)←KeyGen(1^{λ}). The input is the security parameter λ and the output is three keys. The secret key sk is used for decryption, the public key pk is used for encryption, and the evaluation key evk is used to homomorphically compute over encrypted data.
2) Encryption algorithm: ct←Encrypt(pk, m). The encryption algorithm takes in a message m and a public key pk and outputs a ciphertext ct.
3) Decryption algorithm: m′←Decrypt(sk, ct′). The decryption algorithm takes in a ciphertext ct′ and a secret key sk and outputs a message m′.
4) Homomorphic evaluation algorithm: ct_{ƒ}←Eval(evk, ct, ƒ). The homomorphic evaluation algorithm takes in as input an evaluation key evk, a ciphertext ct, and function ƒ. Let m be the message encrypted by ct (i.e. m←Decrypt(sk, ct)). The output of the homomorphic evaluation algorithm is the ciphertext ct_{ƒ} that encrypts ƒ((m).

FHE must satisfy the same security level as a regulation encryption scheme, which dictates that a party without access to the secret key cannot distinguish between encryptions of any two messages, even if the messages are adversarially chosen.

In an embodiment, the CKKS FHE scheme is used to evaluate the LLM. The plaintext space of the CKKS scheme may be expressed as [symbol] ⁿ, where n is typically a power of two. In an embodiment, n=2¹⁶=65536 may be used. In an embodiment, the CKKS scheme supports the following basic operations that are used to construct all of the evaluation circuits:
1) Encrypted addition operation: ct′←EvalAdd(ct₁, ct₂). When the input ciphertexts encrypt messages m₁, m₂∈ [symbol] ⁿ, then the output ciphertext ct′ encrypts m′∈ [symbol] ⁿ such that m′[i]=m₁[i]+m₂[i].
2) Encrypted multiplication operation: ct′←EvalMult(evk, ct₁, ct₂). When the input ciphertexts encrypt messages m₁, m₂∈ [symbol] ⁿ, then the output ciphertext ct′ encrypts m′∈ [symbol] ⁿ such that m′[i]=m₁[i]·m₂[i].
3) Encrypted rotation operation: ct′←EvalRotate(evk_{π}, ct, π), where π:[n]→[n] is a permutation. When the input ciphertexts encrypts the message m∈ [symbol] ⁿ, then the output ciphertext ct′ encrypts m′∈ [symbol] ⁿ such that m′[i]=m[π(i)].

It is noted that the encrypted multiplication operation and the encrypted rotation operation both require evaluation keys. In addition, the evaluation key for the encrypted rotation operation is constructed with knowledge of the permutation a, and a different key is required for a different rotation. For algorithms with many different rotations, the size of these evaluation keys may become significant.

A fundamental concept in FHE performance is the notion of a compute level. An FHE ciphertext supports a finite number of compute levels before it must be refreshed to continue the computation. A ciphertext's compute levels are consumed primarily in the encrypted multiplication operation, where each such operation consumes one level. If the two inputs to this operation have levels [symbol] ₁ and [symbol] ₂, then the output ciphertext will have level [symbol] ′=min( [symbol] ₁, [symbol] ₂)−1. Once a ciphertext's levels have been consumed, further computation would result in a decryption failure. Instead, the ciphertext's levels must be refreshed in an operation that is referred to as bootstrapping.

In an embodiment, the high-level paradigm for designing an FHE evaluation circuit is to first represent the desired function as an arithmetic circuit over [symbol] ⁿ, including only addition, multiplication, and rotation gates. This circuit is then mapped to the encrypted domain, where each gate is replaced by its encrypted operation counterpart. Finally, bootstrapping operations are placed in the circuit to ensure that no encrypted multiplication operation is performed on a ciphertext that has no remaining compute levels.

Natively, FHE only supports additions and multiplications on encrypted data. In an embodiment, other operations, such as exponentiations, inverses, square roots, and others, all needed for LLM evaluation, are approximated by using polynomial methods.

In an embodiment, experiments show that a GPU-accelerated FHE implementation that is based on the present inventive concept provides a speedup that is on the order of hundreds of times faster to perform a forward pass through an LLM, thereby reducing the time required for the forward pass from several hours down to a few minutes. This effectively brings the forward pass time down to a range where non-real-time applications, such as document summarization and/or fine-tuning models on private data, become more practical.

In an embodiment, the CKKS scheme operates over elements of polynomial rings. Let R_{q}:= [symbol] _{q}[x]/(x^{N}+1), where N is a power of 2. The polynomial x^{N}+1 is the 2N^{th} cyclotomic polynomial, and it is assumed that N is fixed throughout the scheme. Conversely, the coefficient modulus q is not fixed in the scheme, and instead changes frequently as the computation progresses, often changing multiple times within a single operation.

The plaintext space of the CKKS scheme is [symbol] ⁿ, where n<N is also a power of 2. As part of the encoding into a ciphertext ring element, the plaintext element of [symbol] ⁿ is scaled by an integer Δ. The exact value of Δ is left undefined, as different implementations take different approaches to define Δ, and the scaling factor is often not the same across ciphertexts or even for the same ciphertext at different points in the computation. Despite this ambiguity, all CKKS plaintexts need a scaling factor, and the current scaling factor is referred to as Δ.

It is important to note that the approximate size of Δ remains the same throughout the computation. This is not technically a requirement of the CKKS scheme, but it is a common property of implementations. It also motivates several later operations that focus on reducing the scaling factor from Δ² back down to Δ. While the actual scaling factor is changing between each step, the high-level picture for this scheme is that all scaling factors are roughly the size of Δ and that Δ² is significantly larger than Δ.

A CKKS ciphertext is typically a pair of ring elements

$$( a , b ) ∈ {R}_{q}^{2} .$$

The secret key s∈R is an element such that b+a·s=Δ·m+e, where e is a short error term that is kept away from the message m by the scaling factor Δ. In general, such error terms are interpreted at elements of the polynomial ring with small norm.

In an embodiment, a focus is placed on the homomorphic operations of ciphertext multiplication and permuting the plaintext vector, since both of these operations require key switching.

Consider two ciphertexts

$$( {a}_{0} , {b}_{0} ) , ( {a}_{1} , {b}_{1} ) ∈ {R}_{q}^{2} ,$$

where (a₀, b₀) encrypts the message m₀∈ [symbol] ⁿ under a secret key s∈R and (a₁, b₁) encrypts the message m₁∈ [symbol] ⁿ under the same secret s. Recall that both of these ciphertexts can be viewed as linear functions over R that give the message when evaluated at s. The goal of the homomorphic multiplication operation is to output an encryption(aᵣₑₛ, bᵣₑₛ) such that aᵣₑₛ·s+bᵣₑₛ=Δ·m₀·m₁+e.

The homomorphic multiplication operation begins by taking two ciphertexts and multiplying them as polynomials in R_{q}[Y]. This results in a quadratic polynomial in (c₀, c₁, c₂)∈R_{q}[Y] such that c₀+s·c₁+s²·c₂=Δ²·m₀·m₁+\tilde{e}, where \tilde{e} is an error with size proportional to Δ. To complete the multiplication operation, two steps are performed: key switching and rescaling.

The goal of the key switching step is to output an encryption of s²·c₂ under the original secret key s. As above, this encryption will be a linear function over R that gives s²·c₂+e′ when evaluated at s (where e′ is a small error). In addition to the ciphertext, key switching requires an additional piece of data called the switching key, which is essentially many different encryptions of s² when evaluated at s (where e′ is a small error). In addition to the ciphertext, key switching requires an additional piece of data called the switching key, which is essentially many different encryptions of s² multiplied by various constants, which support the basis change operations and maintain correctness during scaling. These encryptions are also pairs of polynomial ring elements, although the coefficients of this ring are larger than the coefficients of the ciphertext. The switching key has the following structure:

$${\{ ( {a}_{i} , {b}_{i} ) \}}_{i = 1}^{k} ∈ {R}_{p \cdot q}^{2 \times k} ,$$

where the coefficient modulus is p·q rather than just q.

### Algorithm 1: Key Switching for Homomorphic Multiplication.

Input: The key switching operation begins with (c₀, c₁, c₂) as defined above.
First: Raise the modulus. The operation begin by taking c₂, splitting it into k different elements in R_{q}, then raising the coefficient modulus to obtain k elements d₁, . . . , dₖ∈R_{p·q}. Changing the coefficient modulus is an expensive step, and a major component of the optimization is reducing the number of times that the coefficient modulus must change.
Second: Inner product with the switching key. The vector of elements d₁, . . . , dₖ is multiplied by the switching key to obtain the following values:

$${a}^{′} = {\sum }_{i = 1}^{k} {d}_{i} \cdot {a}_{i} and {b}^{′} = {\sum }_{i = 1}^{k} {d}_{i} \cdot {b}_{i} ,$$

where all (aᵢ, bᵢ) values are from the switching key and all arithmetic is over R_{p·q}. The result is a′, b′∈R_{p·q}.

Third: Reducing the coefficient modulus. The coefficients of a′ and b′ are reduced to the original coefficient modulus q. This is not a simple modular reduction, and is instead more similar to a division by p. The mechanics of this operation are nearly identical to the modulus raising operation in the first step of Algorithm 1. The result is

$$( {a}^{″} , {b}^{″} ) ∈ {R}_{q}^{2} ,$$

which is the desired ciphertext with the property a″·s+b″=s²·c₂+e.

Once this key switching ciphertext is obtained, it is added to the original ciphertext terms (c₀, c₁) to obtain the ciphertext terms a_{Δ}=c₁+a″ and b_{Δ}=c₀+b″ with the following property, where all operations are over R_{q}:

$${a}_{Δ} \cdot s + {b}_{Δ} = {c}_{1} \cdot s + {a}^{″} \cdot s + {c}_{0} + {b}^{″} = {c}_{0} + {c}_{1} \cdot s + {b}^{″} + {a}^{″} \cdot s = {c}_{0} + {c}_{1} \cdot s + {c}_{2} \cdot {s}^{2} + e = {Δ}^{2} {m}_{0} {m}_{2} + {e}^{′} .$$

The ciphertext (a_{Δ}, b_{Δ}) is almost the desired result; the only remaining step is to reduce the Δ² scaling factor back to Δ.

The final rescaling division by Δ is performed as an additional coefficient basis reduction. The ciphertext modulus can be represented as a product of integers q=q₁·q₂· . . . qₗ₋₁·qₗ where each qᵢ is roughly the size of Δ. To complete the homomorphic multiplication, the ciphertext (a_{Δ}, b_{Δ}) is employed to perform the same coefficient reduction operation as in step 3 in the key switching procedure above. The result is the ciphertext

$$( {a}_{res} , {b}_{r e s} ) ∈ {R}_{q / {q}_{ℓ}}^{2}$$

such that aᵣₑₛ·s+bᵣₑₛ=Δ·m₀·m₁+e.

Even though Δ was left unspecified in this explanation, it is important to know the exact value of Δ at each point in the computation. This is because the final decryption needs to know the true Δ value to scale down Δ·m+e to recover the correct message m. Furthermore, it is crucial when two ciphertexts that are added together that both ciphertexts use the same scaling factor, and it is common for ciphertexts that are products of different computations do have different scaling factors. For this reason, an adjustment operation may be performed in order to change the scaling factor of a ciphertext to match the other operand.

Taking a step back, it may be observed that, in the worst case, a multiplication results in a ciphertext passing through three successive basis reduction operations. The first is at the end of key switching, where the basis is reduced from p·q back down to q. The second is in rescaling, where the scaling factor is reduced from Δ² down to Δ. The third is in the adjustment operation described above, where the basis is reduced again to adjust the scaling factor from Δ to Δ′. A succinct description of our optimizations is that all of these basis reduction steps can be combined.

While some of these optimizations reduce the operation count of the CKKS functions, in an embodiment, this does not capture the full improvement in the implementation. This is because CKKS, and more generally all modern FHE schemes, quickly become memory bound as advanced hardware is introduced to speed up the computation. At a high level, the most significant improvement in the overall performance will target the memory usage of these algorithms, which is the main focus of these optimizations.

Consider an element in the ring R_{q}:= [symbol] _{q}[x]/(x^{N}+1), where

$$q = {\prod }_{i = 1}^{ℓ} {q}_{i} .$$

The full modulus q is too large to efficiently perform operations within standard machine words. Instead, the ciphertext ring is split into the product ring R_{q}≃R_{q}_{₁}⊗R_{q}_{₂}⊗ . . . ⊗R_{q}_{ₗ}, where each qᵢ fits into a single machine word. This results in a ring element being stored as an [symbol] ×N matrix of machine words, where the i^{th} row contains an element of R_{q}_{ᵢ} and the j^{th} column contains the j^{th} coefficient in [symbol] _{q} modulo each of the qᵢ factors. The majority of CKKS operations are over individual R_{q}_{ᵢ} elements, so this matrix is stored in row-major order where the locality is within a single row. However, the basis change operations in key switching operate on column-wise data, where all of the residues for a single coefficient must be combined to change the basis of the overall element. The data within a single column of this matrix is spread across multiple cache lines, and it is significantly slower to access the memory in this way. In an embodiment, this is the greatest benefit of the optimizations: there is a reduction in the number of times the ring element data must be accessed in a column-wise manner by combining multiple column-wise operations into a single step.

The following is a description of the CKKS permutation function. In an embodiment, the key switching operation for the permutation function follows the same basic steps as the multiplication key switching, although there are minor differences that are relevant to this implementation. In particular, the following describes how plaintext-ciphertext matrix multiplication is implemented primarily via a series of permutation operations, and this matrix multiplication appears multiple times in the expensive bootstrapping operation.

Recall that the CKKS plaintext space is [symbol] ⁿ. The additional and multiplication operations discussed above operate component-wise over these vectors. This allows for a computation of arbitrary functions of data stored in the same location in the plaintext vectors, but to take full advantage of the vectorized plaintexts, a method to compute on data stored in different locations in the vector is also required.

Define some permutation π: [symbol] ₙ→ [symbol] ₙ. The homomorphic permutation operation takes in a ciphertext

$$( a , b ) ∈ {R}_{q}^{2}$$

that decrypts to a message m∈ [symbol] ⁿ under secret key s and outputs a new ciphertext

$$( {a}_{rot} , {b}_{rot} ) ∈ {R}_{q}^{2}$$

that decrypts to a message mᵣₒₜ=π(m) under the same secret key s.

The homomorphic permutation operation begins by permuting the input ciphertext according to π. Define (a_{π}, b_{π}):=(π(a), π(b)), where π operates over the coefficients. This is almost the desired result, since if the right secret key s_{π}:=π(s) is used, this ciphertext decrypts to the correct message mᵣₒₜ. This means that the ciphertext satisfies a_{π}·s_{π}+b_{π}=Δ·mᵣₒₜ+e, where Δ is the scaling factor and e is small. In order to switch the decryption key from s_{π} back to s, a key switching operation is used.

The structure of the switching key for the rotation operation is the same as above:

$${\{ ( {a}_{i} , {b}_{i} ) \}}_{i = 1}^{k} ∈ {R}_{p \cdot q}^{2 \times k}$$

where the coefficient modulus is p·q rather than just q. Let (a_{π}, b_{π}) be the ciphertext at the start of key switching. Similar to the key switching in homomorphic multiplication, the goal of this operation is to produce a ciphertext (a′, b′) that “decrypts” to a_{π}·s_{π} under the original key s. In other words, this final output ciphertext satisfies a′·s+b′=a_{π}·s_{π}+e, where e is small. The steps to produce this ciphertext are identical to those described above.

In an embodiment, once this ciphertext is obtained, it is possible to compute (aᵣₒₜ, bᵣₒₜ)=(a′, b′+b_{π}). This ciphertext satisfies the following equation:

$${a}_{rot} \cdot s + {b}_{rot} = {a}^{′} \cdot s + {b}^{′} + {b}_{π} = {a}_{π} \cdot {s}_{π} + e + {b}_{π} = Δ \cdot {m}_{rot} + e$$

where the error terms are implicitly added on the last line.

In an embodiment, the following is a description of optimizations for homomorphic multiplication. Recall that the basis reduction operation from R_{p·q} down to R_{q} computes a division by p over the integers. This means that (a″, b″)≈(└a′/p┘, └b′/p┘). Instead dividing by p then adding (d₁, d₀), d₁ and d₀ can be scaled up by p to add them before scaling down. The benefit of adding d₀ and d₁ first is that the basis reduction at the end of algorithm 1 and the rescaling operation that occurs immediately after algorithm 1 can now be merged into a single basis reduction operation. The intuition for this is that both operations are computing something approximating a quotient, so a simple division by a larger factor may be performed. The result is Algorithm 2 below, which outputs a ciphertext with the same properties as the final rescaled ciphertext from the textbook operation.

A key trick in this new algorithm is a method to bypass the expensive modulus raising operation when the output is scaled by the new modulus factor. In more detail, consider an element d∈R_{q}, and it is desired to compute the element p·d∈R_{p·q}, where both the element d and the coefficient modulus q are scaled by p. If only the increased basis of d were to be computed, this would require the same expensive basis change operation as in step 1 of key switching. However, it may be observed that the components of the new basis of p·d are always 0, since p·d≡0 mod p for any d. This computation, which is now just a scalar product by p modulo p·q, is extremely efficient and can be performed without changing the orientation of the data.

### Algorithm 2: Merged Key Switching & Rescaling for Homomorphic Multiplication.

Input: The key switching operation begins with the same (c₀, c₁, c₂) as in algorithm 1.
First: Raise the modulus. Same as in Algorithm 1 as described above.
Second: Inner product with the switching key. Same as in Algorithm 1 as described above. The result a′, b′∈R_{p·q}.
Third: Scaling and adding the message. The ciphertext terms c₀ and c₁ are scaled by p to get p·c₀, p·c₁∈R_{p·q}. Observe that the coefficient modulus also grows to p·q. Unlike the modulus raising operation in the first step above, this operation is very fast. These terms are added to the inner product result to get

$$( {a}_{big} , {b}_{big} ) = ( {a}^{′} + p \cdot {c}_{1} , {b}^{′} + p \cdot {c}_{0} ) ∈ {R}_{p \cdot q}^{2} .$$

Fourth: Reducing the coefficient modulus. The coefficient modulus is now reduced from p·q all the way down to q/qₗ, which is the final output of the rescaling. The result is a ciphertext

$$( {a}_{res} , {b}_{res} ) ∈ {R}_{q / {q}_{ℓ}}^{2}$$

such that aᵣₑₛ·s+bᵣₑₛ=Δ·m₀·m₁+e, which is the same as the final rescaling output.

In an embodiment, the rescaling in the adjustment operation may be merged into the fourth step of Algorithm 2 in the same way by multiplying by the appropriate scaling factor and scaling down to the correct coefficient modulus. The result is three distinct basis reduction operations in the textbook CKKS scheme replaced with just one such operation.

The applications of this optimization to encrypted linear algebra are described below. In an embodiment, a starting point is a simple inner product operation between two encrypted vectors. A description is then provided regarding how this optimization accelerates the multiplication between a plaintext matrix and an encrypted vector, which comprises two of the three phases of CKKS bootstrapping.

Consider two encrypted vectors u, v

$$∈ {R}_{q}^{2 \times ℓ} ,$$

where each vector consists of [symbol] ciphertexts. It is desired to compute the encrypted inner product

$$w = {\sum }_{i = 1}^{ℓ} EvalMult ( {u}_{i} , {v}_{i} , rlk ) ,$$

where uᵢ and vᵢ are the i^{th} elements of u and v and rlk is the switching key.

If this algorithm is executed using the textbook homomorphic operations, [symbol] full key switching operations that include [symbol] modulus raising operations and [symbol] modulus reduction operations will be performed. In an embodiment, an optimization removes nearly all of the basis reduction steps from this inner product. The method extends the technique of raising the message to the larger key switching modulus by observing that linear operations can be performed over these raised messages.

At a high level, this is a fusing of all [symbol] of the EvalMult operations as well as the [symbol] −1 encrypted sum operations in the inner product.

### Algorithm 3: Optimized Encrypted Inner Product.

Input: This inner product algorithm begins with two vectors of ciphertexts u, v of length [symbol] . It is assumed that all ciphertexts are members of

$${R}_{q}^{2}$$

and decrypt as linear functions of a secret s∈R_{q}.
First: Begin all multiplications. For each i∈[ [symbol] ], multiply

$${u}_{i} , {v}_{i} ∈ {R}_{q}^{2}$$

over R_{q}[Y] to get

$$\begin{matrix}{u}_{i} ( Y ) \cdot {v}_{i} ( Y ) = ( {d}_{i}^{( 0 )} , {d}_{i}^{( 1 )} , {d}_{i}^{( 2 )} ) ∈ {R}_{q}^{3} \\ \begin{matrix}{u}_{i} ( s ) = Δ \cdot {μ}_{i} + e & {v}_{i} ( s ) = Δ \cdot {v}_{i} + e\end{matrix} \\ {d}_{i}^{( 0 )} + s \cdot {d}_{i}^{( 1 )} + {s}^{2} \cdot {d}_{i}^{( 2 )} = {Δ}^{2} {μ}_{i} {v}_{i} + {e}^{′} .\end{matrix}$$

Second: Raise the modulus. For each

$${d}_{i}^{( 2 )}$$

as defined in the previous step, raise the modulus as in the first step in Algorithm 1. The result is k elements in R_{p·q} for each i∈[ [symbol] ].
Third: Inner product with the switching key. For each raised set of raised digits, apply the second step from Algorithm 1. The result

$${a}_{i}^{′} , {b}_{i}^{′} ∈ {R}_{p \cdot q} .$$

Fourth. Scaling and adding the message. Apply the third step in Algorithm 2 to all

$${d}_{i}^{( 0 )} , {d}_{i}^{( 1 )}$$

terms. This step scales all ciphertext terms

$${d}_{i}^{( 0 )} , {d}_{i}^{( 1 )}$$

by p to get

$$p \cdot {d}_{i}^{( 0 )} , p \cdot {d}_{i}^{( 1 )} ∈ {R}_{p \cdot q}^{2} .$$

Recall that this raising operation is very fast. These terms are to the inner product result to get

$$( {w}_{i , big}^{( 1 )} , {w}_{i , big}^{( 0 )} ) = ( {a}_{i}^{′} + p \cdot {d}_{i}^{( 1 )} , {b}_{i}^{′} + p \cdot {d}_{i}^{( 0 )} ) ∈ {R}_{p \cdot q}^{2} .$$

Fifth: Complete the Inner Product. All

$$( {w}_{i , big}^{( 1 )} , {w}_{i , big}^{( 0 )} )$$

tuples are summed together in order to obtain

$$( {w}_{i , big}^{( 1 )} , {w}_{i , big}^{( 0 )} ) = ( {\sum }_{i = 1}^{ℓ} {w}_{i , big}^{( 1 )} , {\sum }_{i = 1}^{ℓ} {w}_{i , big}^{( 0 )} )$$

where all arithmetic is over R_{p·q}.
Sixth: Reducing the coefficient modulus. The fourth step from Algorithm 2 is now performed on the tuple

$$( {w}_{i , big}^{( 1 )} , {w}_{i , big}^{( 0 )} ) .$$

This step reduces the coefficient modulus from p·q all the way down q/qₗ, which is the final output of the rescaling. The result is a ciphertext

$$w = ( {w}_{1} , {w}_{0} ) ∈ {R}_{q / {q}_{ℓ}}^{2}$$

such that

$${w}_{1} \cdot s + {w}_{0} = Δ \cdot ( {\sum }_{i = 1}^{ℓ} {μ}_{i} \cdot {v}_{i} ) + e ,$$

which is the desired output of the encrypted inner product.

At the end of the fourth step in Algorithm 3 above, a “ciphertext” that encrypts

$$p \cdot {Δ}^{2} \cdot {\sum }_{i = 1}^{ℓ} {μ}_{i} \cdot {v}_{i}$$

is provided, which is the correct output scaled by both p·Δ. In the final step, there is one downscaling by this entire additional scaling factor, thereby allowing to obtain the correct result with only one basis reduction operation. In the textbook construction, at least l distinct basis reduction operations would have been required to be performed. This optimization reduces both the operation count and the memory of the encrypted inner product operation.
In an embodiment, a similar optimization to the operation of multiplying a plaintext matrix by an encrypted vector is now performed. This is an extremely important operation in CKKS, since two out of the three phases of CKKS bootstrapping consist of this plaintext-ciphertext matrix-vector product. Let V∈ [symbol] ^{n×n} be the plaintext matrix, and let vᵢ∈ [symbol] ⁿ be the i^{th} row of V. Let

$$( a , b ) ∈ {R}_{q}^{2}$$

be the encryption of the vector under secret key s∈R_{q}. At a high level, the plaintext-ciphertext matrix-vector product has the form

$$w = {\sum }_{i = 1}^{n} ( Δ \cdot {v}_{i} ) \cdot Rotate ( ( a , b ) , i , {rlk}_{i} ) ,$$

where Rotate(⋅, i, rlkᵢ), is the permutation operation that shifts the plaintext vector by i positions, and rlkᵢ is the switching key for this permutation. Note that the plaintext vᵢ is scaled by Δ since the scalar values in vᵢ may not be integers. The textbook CKKS implementation of this sum will require a rescaling at the end of this operation, which is in addition to the n basis reduction operations that would need to occur for each Rotate( ). As with the inner product above, this rescaling is absorbed into the single basis reduction step that additionally combines all n basis reduction operations from the textbook implementation.

### Algorithm 4: Optimized Plaintext-Ciphertext Matrix-Vector Product.

Input: Algorithm 4 begins with a plaintext matrix V∈ [symbol] ^{n×n} and a ciphertext

$$( a , b ) ∈ {R}_{q}^{2}$$

that encrypts x∈ [symbol] ⁿ.
First: Raise the modulus. Begin by raising the modulus of a∈R_{q} as in the first step in Algorithm 1. The result is k elements in ã₁, . . . , ãₖ∈R_{p·q}.
Second: Compute the rotations. For each i∈[n], apply the rotation to the digits ã₁, . . . , ãₖ computed above as well as the b∈R_{q} term that contains the encrypted vector. Let bᵢ∈R_{q} denote the rotated b value.
Third: Inner product with each switching key. For each rotation i∈[n], apply the second step from Algorithm 1 on the rotated raised digits. The result

$${a}_{i}^{′} , {b}_{i}^{′} ∈ {R}_{p \cdot q} .$$

Fourth: Scaling and adding the message. Apply the third step in Algorithm 2 to all bᵢ terms to get p·bᵢ∈R_{p·q}. Recall that this raising operation is very fast. These terms are added to the inner product results to get

$$( {a}_{i , big} , {b}_{i , big} ) = ( {a}_{i}^{′} , {b}_{i}^{′} + p \cdot {b}_{i} ) ∈ {R}_{p \cdot q}^{2} .$$

Fifth: Multiply by the Plaintext Vectors and Sum. For each (a_{i,big}, b_{i,big}) tuple, multiply by Δ·vᵢ to obtain

$$( {a}_{big} , {b}_{big} ) = ( {\sum }_{i = 1}^{n} ( Δ \cdot {v}_{i} ) \cdot {a}_{i , big} , {\sum }_{i = 1}^{n} ( Δ \cdot {v}_{i} ) \cdot {b}_{i , big} )$$

where all arithmetic is over R_{p·q}.
Sixth: Reducing the coefficient modulus. The fourth step from Algorithm 2 is now performed on the tuple (a_{big}, b_{big}). This step reduces the coefficient modulus from p·q all the way down to q/qₗ, which is the final output of the rescaling. The result is a ciphertext

$$w = ( {w}_{1} , {w}_{0} ) ∈ {R}_{q / {q}_{ℓ}}^{2}$$

such that w₁·s+w₀=Δ·V·x+e, which is the desired output of the encrypted inner product.

In an embodiment, this optimization is particularly powerful since it reduces the number of basis change operations from O( [symbol] ) to only two, one to raise the modulus in the first step, and the second to reduce the modulus in the final step. This is a constant number of basis change operations regardless of the size of the matrix.

In some embodiments as disclosed above in FIGS. 1-4, technical improvements effected by the instant disclosure may include a platform for implementing an FHE-based privacy-preserving LLM inference module configured for enablement of providing an FHE-based privacy-preserving LLM inference via a GPU-based implementation, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing a privacy-preserving large language model (LLM) inference, the method being implemented by at least one processor, the method comprising:
receiving, from a user, a query that is encrypted;
providing, to an LLM, a graphics processing unit (GPU)-based implementation of a transformer architecture that is configured to accelerate homomorphic operations of the LLM;
inputting the query into the LLM with the GPU-based implementation of the transformer architecture;
receiving, from the LLM, an encrypted response to the query; and
decrypting the encrypted response,
wherein the LLM is unable to decrypt the query.

2. The method of claim 1, wherein the query is encrypted by:
using a tokenizer of the LLM to transform text included in the query into a sequence of real-valued vectors; and
encrypting the sequence of real-valued vectors by using a predetermined encryption algorithm.

3. The method of claim 1, wherein the query is encrypted by using a fully homomorphic encryption (FHE) scheme.

4. The method of claim 3, wherein the FHE scheme comprises:
a key generation algorithm that is configured to generate a public key that is usable for encryption, a secret key that is usable for decryption, and an evaluation key;
an encryption algorithm that is configured to apply the public key to an input message to generate an output ciphertext;
a decryption algorithm that is configured to apply the secret key to an input ciphertext to generate an output message; and
a homomorphic evaluation algorithm that is configured to apply the evaluation key to an input ciphertext for a first message and an input function to generate an output ciphertext that encrypts a result of encrypting a result of applying the input function to the first message.

5. The method of claim 3, wherein the GPU-based implementation of the transformer architecture comprises a GPU-accelerated Cheon-Kim-Kim-Song (CKKS) FHE scheme,
wherein the CKKS FHE scheme comprises a key switching algorithm that is configured to increase a modulus of the input ciphertext, perform at least one homomorphic operation on the input ciphertext at the increased modulus, and decrease the modulus of the input ciphertext.

6. The method of claim 5, wherein the CKKS FHE scheme comprises performing each of an encrypted addition operation, an encrypted multiplication operation, and an encrypted rotation operation.

7. The method of claim 6, wherein the CKKS FHE scheme further comprises using at least one polynomial approximation for replacing at least one function of the transformer architecture with a function that is operable on encrypted data, and wherein the at least one polynomial approximation is based on a selection of parameters that are optimized fora balance between a runtime of the CKKS FHE scheme and an accuracy of the LLM.

8. The method of claim 5, wherein the CKKS FHE scheme has a plaintext space that corresponds to a set having a dimension that is equal to 65,536.

9. The method of claim 1, wherein the LLM includes an open-source LLM.

10. A computing apparatus for providing a privacy-preserving large language model (LLM) inference, the computing apparatus comprising:
a processor;
a memory; and
a communication interface coupled to each of the processor and the memory,
wherein the processor is configured to:
receive, from a user via the communication interface, a query that is encrypted;
provide, to an LLM, a graphics processing unit (GPU)-based implementation of a transformer architecture that is configured to accelerate homomorphic operations of the LLM;
input the query into the LLM with the GPU-based implementation of the transformer architecture;
receive, from the LLM, an encrypted response to the query; and
decrypt the encrypted response,
wherein the LLM is unable to decrypt the query.

11. The computing apparatus of claim 10, wherein the query is encrypted by:
using a tokenizer of the LLM to transform text included in the query into a sequence of real-valued vectors; and
encrypting the sequence of real-valued vectors by using a encryption algorithm.

12. The computing apparatus of claim 10, wherein the query is encrypted by using a fully homomorphic encryption (FHE) scheme.

13. The computing apparatus of claim 12, wherein the FHE scheme comprises:
a key generation algorithm that is configured to generate a public key that is usable for encryption, a secret key that is usable for decryption, and an evaluation key;
an encryption algorithm that is configured to apply the public key to an input message to generate an output ciphertext;
a decryption algorithm that is configured to apply the secret key to an input ciphertext to generate an output message; and
a homomorphic evaluation algorithm that is configured to apply the evaluation key to an input ciphertext for a first message and an input function to generate an output ciphertext that encrypts a result of encrypting a result of applying the input function to the first message.

14. The computing apparatus of claim 12, wherein the GPU-based implementation of the transformer architecture comprises a GPU-accelerated Cheon-Kim-Kim-Song (CKKS) FHE scheme,
wherein the CKKS FHE scheme comprises a key switching algorithm that is configured to increase a modulus of the input ciphertext, perform at least one homomorphic operation on the input ciphertext at the increased modulus, and decrease the modulus of the input ciphertext.

15. The computing apparatus of claim 14, wherein the CKKS FHE scheme comprises performing each of an encrypted addition operation, an encrypted multiplication operation, and an encrypted rotation operation.

16. The computing apparatus of claim 15, wherein the CKKS FHE scheme further comprises using at least one polynomial approximation for replacing at least one function of the transformer architecture with a function that is operable on encrypted data, and wherein the at least one polynomial approximation is based on a selection of parameters that are optimized for a balance between a runtime of the CKKS FHE scheme and an accuracy of the LLM.

17. The computing apparatus of claim 14, wherein the CKKS FHE scheme has a plaintext space that corresponds to a set having a dimension that is equal to 65,536.

18. The computing apparatus of claim 10, wherein the LLM includes an open-source LLM.

19. A non-transitory computer readable storage medium storing instructions for providing a privacy-preserving large language model (LLM) inference, the storage medium comprising executable code which, when executed by a processor, causes the processor to:
receive, from a user, a query that is encrypted;
provide, to an LLM, a graphics processing unit (GPU)-based implementation of a transformer architecture that is configured to accelerate homomorphic operations of the predetermined LLM;
input the query into the LLM with the GPU-based implementation of the transformer architecture;
receive, from the LLM, an encrypted response to the query; and
decrypt the encrypted response,
wherein the LLM is unable to decrypt the query.

20. The storage medium of claim 19, wherein the query is encrypted by:
using a tokenizer of the LLM to transform text included in the query into a sequence of real-valued vectors; and
encrypting the sequence of real-valued vectors by using a predetermined encryption algorithm.
